(19) United States
(12) Patent Application Publication
(10) Pub. No.: US 2025/0050269 A1
(43) Pub. Date: Feb. 13, 2025

(54) GAS SEPARATION MEMBRANE, GAS SEPARATION MEMBRANE MODULE, AND GAS PERMEABLE APPARATUS

(71) Applicant: Hitachi-GE Nuclear Energy, Ltd., Ibaraki (JP)

(72) Inventors: Mina AMO, Tokyo (JP); Tomohisa SUZUKI, Tokyo (JP)

(21) Appl. No.: 18/788,283

(22) Filed: Jul. 30, 2024

(30) Foreign Application Priority Data
Aug. 10, 2023 (JP) 2023-131094

(51) Int. Cl. B01D 53/22

(52) U.S. Cl. CPC B01D 53/228; B01D 2053/223; B01D 2317/06

(57) ABSTRACT

Provided are a gas separation membrane having a gas separation property and gas permeability and having heat resistance and pressure resistance even under an extremely high temperature and high pressure water vapor atmosphere, which is not a related-art product, a gas separation membrane module, and a gas permeable apparatus. A gas separation membrane according to the present embodiment includes a polyimide resin and a scaly filler. In a gas separation membrane module according to the present embodiment, the gas separation membrane is disposed in a closed container having a mixed gas inlet, a permeable gas outlet, and a non-permeable gas outlet. A gas permeable apparatus according to the present embodiment includes two or more gas separation membrane modules in which the above-described gas separation membrane is disposed in the closed container having the mixed gas inlet, the permeable gas outlet, and the non-permeable gas outlet.

### CROSS REFERENCE TO RELATED APPLICATIONS

This application claims the foreign priority benefit under 35 U.S.C. § 119 of Japanese patent application No. 2023-131094, filed on Aug. 10, 2023, the disclosure of which is incorporated herein by reference.

### BACKGROUND OF THE INVENTION

### 1. Field of the Invention

The present invention relates to a gas separation membrane, a gas separation membrane module, and a gas permeable apparatus.

### 2. Description of Related Art

Gas separation using a gas separation membrane is a method that can be implemented by a resource-saving, energy-saving, and compact apparatus, and is widely used in various fields such as petrochemistry, chemistry, precision machinery, food, automobile, nuclear power, environment, biotechnology, and medical fields, and importance thereof is increasing.

Examples of a polymer material used in such a gas separation membrane include cellulose acetate, a polydimethylsiloxane, ethyl cellulose, a polysulfone, an ethylene-propylene copolymer, a polypropylene, a polyamide, and a polyimide.

For example, PTL 1 proposes a gas separation membrane made of a polyimide including a specific repeating unit. According to PTL 1, it is described that the gas separation membrane can be suitably used for gas separation of an organic vapor mixture mainly containing an organic vapor and a water vapor, for example, by bringing the organic vapor mixture into contact with the gas separation membrane, thereby selectively allowing the water vapor to permeate.

A method of containing an additive such as a filler in a separation membrane is proposed as a method for improving a strength and separation performance of the separation membrane.

For example, PTL 2 discloses adding a plate-shaped filler to a specific propylene-based polymer. PTL 2 discloses that by doing so, it is possible to provide a propylene-based resin composition having high rigidity and excellent balance between low temperature impact resistance and a low linear expansion coefficient.

For example, PTL 3 discloses that a porous membrane made of polyarylene sulfide contains a reinforcing material such as mica or a glass flake as an additive.

### CITATION LIST

### Patent Literature

PTL 1: JP2010-201417A
PTL 2: JP2017-218517A
PTL 3: JP2010-254943A

### SUMMARY OF THE INVENTION

In recent years, gas separation technology using a separation membrane has been attracting attention as a move toward carbon neutrality. In many cases, it is expected that an operating condition is harsher than an environment in which it has been used thus far, for example, in a high temperature and high pressure water vapor environment of 150° C. or higher. Therefore, the separation membrane is required to have not only permeability but also pressure resistance and heat resistance capable of withstanding the harsh operating condition.

However, when the separation membrane is made of the polyimide described above, oxidative deterioration or hydrolysis may occur due to influence of temperature, pressure, and water vapor in the high temperature and high pressure water vapor environment as described above, making it impossible to maintain the pressure resistance. In a case of the propylene-based resin described above, by containing a filler in the membrane, even if the strength of the membrane is maintained in a low temperature range, the membrane may be broken and not function as a separation membrane due to insufficient heat resistance and pressure resistance in a high temperature range. The polyarylene sulfide described above has excellent heat resistance and water resistance, but may be broken by water hammer (water hammer action) due to pressure fluctuations of water or water vapor, and not function as a separation membrane.

The invention has been made in view of the above situation. An object of the invention is to provide a gas separation membrane having a gas separation property and gas permeability and having heat resistance and pressure resistance even under an extremely high temperature and high pressure water vapor atmosphere, which is not a related-art product, a gas separation membrane module, and a gas permeable apparatus.

The gas separation membrane according to the invention that solves the above problems includes a polyimide resin and a scaly filler.

According to the invention, it is possible to provide a gas separation membrane having a gas separation property and gas permeability and having heat resistance and pressure resistance even under an extremely high temperature and high pressure water vapor atmosphere, which is not a related-art product, a gas separation membrane module, and a gas permeable apparatus.

Problems, configurations, and effects other than those described above will become apparent from the following description of embodiments.

### BRIEF DESCRIPTION OF THE DRAWINGS

FIG. 1 is a schematic cross-sectional view showing an example of a gas separation membrane according to a first embodiment of the invention.

FIG. 2 is a schematic cross-sectional view showing an example of a gas separation membrane according to a second embodiment of the invention.

FIG. 3 is a schematic cross-sectional view showing an example of a gas separation membrane module according to a third embodiment of the invention.

FIG. 4 is a schematic cross-sectional view showing an example of a gas separation membrane module according to a fourth embodiment of the invention.

FIG. 5 is a schematic cross-sectional view showing an example of a gas permeable apparatus according to a fifth embodiment of the invention.

FIG. 6 is a schematic cross-sectional view showing another example of the gas permeable apparatus according to the fifth embodiment of the invention.

FIG. 7 is a schematic cross-sectional view showing still another example of the gas permeable device according to the fifth embodiment of the invention.

FIG. 8 is a schematic cross-sectional view showing an example of a gas permeable apparatus according to a sixth embodiment of the invention.

FIG. 9 is a schematic cross-sectional view showing another example of the gas permeable apparatus according to the sixth embodiment of the invention.

FIG. 10 is a schematic cross-sectional view showing still another example of the gas permeable apparatus according to the sixth embodiment of the invention.

FIG. 11 is a schematic view showing an example of a gas separation membrane module using spiral type gas separation membranes.

### DESCRIPTION OF EMBODIMENTS

Hereinafter, a gas separation membrane, a gas separation membrane module, and a gas permeable apparatus according to the present embodiment will be described in detail with reference to the drawings as appropriate. In some embodiments to be described below, the same components are denoted by the same reference numerals, and detailed description thereof may be omitted.

### Gas Separation Membrane

FIG. 1 is a schematic cross-sectional view showing an example of a gas separation membrane 10 according to a first embodiment of the invention. FIG. 1 illustrates a case where the gas separation membrane 10 is a flat membrane.

As shown in FIG. 1, the gas separation membrane 10 includes a polyimide resin 1 and a scaly filler 2.

The polyimide resin 1 is one of super engineering plastics, and is known to have excellent mechanical properties and heat resistance. The gas separation membrane 10 has a gas separation property and gas permeability due to the polyimide resin 1, and a size of a permeable molecule can be equal to or smaller than a size of a water molecule, more specifically, equal to or smaller than a size of a water vapor (a dynamic molecular diameter of the water vapor is 0.3 nm or less) due to being in a high temperature and high pressure state. Here, the water vapor has substantially the same dynamic molecular diameter as hydrogen, and the magnitude thereof is 0.265 nm (2.65 Å). The dynamic molecular diameter of hydrogen is 0.289 nm (2.89 Å). A dynamic molecular diameter of helium is 0.26 nm (2.6 Å). Methane, carbon monoxide, and carbon dioxide have substantially the same dynamic molecular diameter as nitrogen, and are considered to be relatively large gas molecules. Specifically, the dynamic molecular diameter is 0.36 nm (3.6 Å) for nitrogen, 0.38 nm (3.8 Å) for methane, 0.376 nm (3.76 Å) for carbon monoxide, and 0.33 nm (3.3 Å) for carbon dioxide. Therefore, the gas separation membrane 10 according to the present embodiment allows the water vapor, hydrogen, and helium to permeate, but does not allow substances having a dynamic molecular diameter larger than 0.3 nm, such as nitrogen, methane, carbon monoxide, and carbon dioxide, to permeate.

In the present embodiment, heat resistance and pressure resistance under an extremely high temperature and high pressure water vapor atmosphere (for example, under a water vapor supply condition of 180° C. and 0.5 MPaG) are provided by containing the scaly filler 2 in the gas separation membrane 10. By intentionally introducing the scaly filler 2 into the polyimide resin 1, partial disturbance occurs in a packing state of the polyimide resin 1, and an effect of facilitating gas permeation is thereby obtained.

As shown in FIG. 1, the gas separation membrane 10 is formed on a porous support 3 that supports the gas separation membrane 10. The pressure resistance of the gas separation membrane 10 can be further improved by providing the porous support 3. A plurality of gas separation membranes 10 can be stacked to maintain the pressure resistance. When sufficient pressure resistance can be maintained by stacking the plurality of gas separation membranes 10, the porous support 3 may not be provided. When one gas separation membrane 10 has sufficient pressure resistance, the plurality of gas separation membranes 10 may not be stacked or the porous support 3 may not be provided.

The polyimide resin 1 contains a diamine component and a tetracarboxylic acid component.

The diamine component constituting the polyimide resin 1 may be an aliphatic diamine, and is preferably an aromatic diamine or a heterocyclic diamine for exhibiting high heat resistance. Examples of the diamine component include m-phenylenediamine, p-phenylenediamine, 2,4-tolylenediamine, 3,3′-diaminodiphenyl ether, 4,4′-diaminodiphenyl ether, 3,4′-diaminodiphenyl ether, 3,3′-diaminodiphenyl sulfone, 4,4′-diaminodiphenyl sulfone, 3,4′-diaminodiphenyl sulfone, 3,3′-diaminodiphenyl methane, 4,4′-diaminodiphenyl methane, 3,4′-diaminodiphenyl methane, 4,4′-diaminodiphenyl sulfide, 3,3′-diaminodiphenyl ketone, 3,4′-diaminodiphenyl ketone, 2,2′-bis(4-aminophenyl) propane, 2,2′-bis(4-aminophenyl) hexafluoropropane, 2,2-bis [4-(4-aminophenoxy)phenyl]hexafluoropropane, 1,3-bis(3-aminophenoxybenzene), 1,3-(4-aminophenoxybenzene), 1,4-bis(3-aminophenoxybenzene), 1,4-bis(4-aminophenoxybenzene), N,N′-bis(4-aminophenyl)-N,N′-diphenylbenzidine, 4-methyl-2,4-bis(4-aminophenyl)-1-pentene, N,N′-bis(4-aminophenyl)-N,N′-diphenylenediamine, 4-methyl-2,4-bis(4-aminophenyl)-2-pentene, 4,4′-bis(4-aminophenoxy) biphenyl, 4,4′-bis(3-aminophenoxy) biphenyl, 4,4′-diaminotriphenylamine, 1,5-diaminonaphthalene, 2,6-diaminonaphthalene, 4-methyl-2,4-bis(p-aminophenylpentane), 5 or 6-amino-1-(p-aminophenyl)-1,3,3-trimethylindane, bis(p-aminophenyl) phosphine oxide, 4,4′-diaminoazobenzene, 4,4′-diaminodiphenylurea, 2,2-bis [p-(p′-aminophenoxy)phenyl]propane, 2,2-bis [p-(m-aminophenoxy)phenyl]benzophenone, 4,4′-bis(p-aminophenoxy) diphenylsulfone, 9,9-bis(4-aminophenyl) fluorene, 2,7-diaminofluorene, benzoguanamine, acetoguanamine, and 3,6-diaminocarbazole. A compound may be used in which the hydrogen atom of these aromatic diamines is substituted with at least one substituent selected from the group including a chlorine atom, a fluorine atom, a bromine atom, a methyl group, a methoxy group, a cyano group, and a phenyl group.

Examples of the tetracarboxylic acid component constituting the polyimide resin 1 include a tetracarboxylic dianhydride, which has a tetravalent group. Examples of the tetracarboxylic acid component include pyromellitic anhydride, 4,4′-oxydiphthalic anhydride, 3,4′-oxydiphthalic anhydride, 3,3′,4,4′-biphenyltetracarboxylic dianhydride, 4,4′-(hexafluoroisopropylidene)diphthalic anhydride, 3,3′,4,4′-benzophenonetetracarboxylic dianhydride, 3,3′,4,4′-diphenylsulfonetetracarboxylic dianhydride, 9,9-bis(3,4-dicarboxyphenyl) fluorene dianhydride, norbornane-2-spiro-α-cyclopentanone-α′-spiro-2″-norbornane-5,5″,6,6″-tetracarboxylic dianhydride, bis(1,3-dihydro-1,3-dioxoisobenzofuran-5-carboxylic acid) ethane-1,2-diyl, bis(1,3-dioxo-1,3-dihydroisobenzofuran-5-carboxylic acid) 1,4-phenylene, and naphthalene-1,4,5,8-tetracarboxylic dianhydride. A compound may be used in which a tetracarboxylic dianhydride, which has a tetravalent group, is substituted with a tetracarboxylic diester or a dithioanhydride.

As a method for manufacturing the polyimide resin 1, a known method in the related art can be applied as described below.
(1) A method in which a diamine and a tetracarboxylic acid component are reacted in a solvent to form a polyamic acid, which is then formed into a film or the like, followed by being heated to form an imide bond.
(2) A method in which a diamine and a tetracarboxylic acid component are reacted under heating to directly form a polyimide bond.

In the method (1) described above, for example, 4,4′-diaminodiphenyl ether is used as the diamine component and pyromellitic anhydride is used as the tetracarboxylic acid component, and both are condensed in a polar organic solvent to obtain a polyamic acid solution. Thereafter, the polyamic acid solution is applied to a glass plate or the like and dried by heating, and peeling off from the glass plate can be performed to manufacture the polyimide resin 1 having a flat membrane shape (film shape). A membrane thickness can be controlled to any desired thickness by adjusting a concentration and an amount of the polyamic acid solution to be applied. In this case, the organic solvent is preferably a polar solvent such as N-methyl-2-pyrrolidone, N,N-dimethylacetamide, N,N-dimethylformamide, or N,N-dimethylsulfoxide. An imidization reaction may be a chemical imidization using acetic anhydride or the like.

For example, at least one of mica, silica, boron nitride, and a glass flake can be used as the scaly filler 2. By using these, it is possible to more reliably provide heat resistance and pressure resistance under an extremely high temperature and high pressure water vapor atmosphere.

In the present embodiment, the gas separation membrane 10 having improved heat resistance and pressure resistance can be obtained by containing the scaly filler 2 in a polyamic acid or polyamic acid ester and then performing an imidization reaction to form a membrane (film) made of the polyimide resin 1 containing the scaly filler 2.

In the present embodiment, the gas separation membrane 10 can also be manufactured by containing the scaly filler 2 in an aromatic polyimide solution and then removing the solvent by heating.

In the present embodiment, the scaly filler 2 is preferably arranged in a direction perpendicular to a gas permeation direction. In this way, when the scaly filler 2 is arranged in the direction perpendicular to the gas permeation direction, the pressure resistance can be more effectively exhibited due to a large area in a surface direction against a gas pressure.

Such a mode of the scaly filler 2 can be implemented by casting a varnish (solution of a polyamic acid or polyamic acid ester) containing the scaly filler 2 onto a glass and then leaving the varnish still for a predetermined time. It is preferable to perform deaeration when leaving the varnish still. Since the leaving-still time varies depending on a type of the polyamic acid or polyamic acid ester used, a type of the scaly filler 2, or the like, it is preferable to confirm this by conducting a test or the like in advance. An example of the leaving-still time is to perform a deaeration treatment at room temperature under a reduced pressure for three hours, but is not limited thereto.

A content of the scaly filler 2 is preferably 0.2% by mass or more and 30% by mass or less, and more preferably 0.5% by mass ore more and 20% by mass or less. When the content of the scaly filler 2 is 0.2% by mass or more, a degree of increase in a solid content in the varnish is sufficient, and the heat resistance and the pressure resistance can be more reliably improved. On the other hand, when the content of the scaly filler 2 is 30% by mass or less, it is not difficult or impossible for a gas to permeate the gas separation membrane 10. It can be calculated according to filler content (% by mass)=filler mass/(filler mass+varnish solid content mass)×100.

An average particle diameter of the scaly filler 2 is preferably 2 μm or more and 30 μm or less, and more preferably 2 μm or more and 10 μm or less. When the average particle diameter of the scaly filler 2 is 2 μm or more, particles are difficult to aggregate and thus can be uniformly dispersed in the varnish. When the average particle diameter of the scaly filler 2 is 30 μm or less, the particles are not excessively large, and thus a tensile strength or the like of the polyimide resin 1 is unlikely to decrease. Therefore, the heat resistance and the pressure resistance of the gas separation membrane 10 can be more reliably improved.

In the present embodiment, a dispersant may be added to the varnish in order to adjust a viscosity of the varnish. An amount of the dispersant added is preferably 0.001 or more and 0.01 or less in terms of weight ratio to the polyimide resin 1. In the present embodiment, the scaly filler 2 may be provided with a dispersant. A nonionic surfactant can be preferably used as the dispersant. Examples of the dispersant include BYK-W903, BYK-W996, and BYK-W9010 manufactured by BYK Chemie Japan Co., Ltd.

An aspect ratio of the scaly filler 2 is preferably 10 or more and 30 or less, and more preferably 15 or more and 30 or less. In this way, the scaly filler 2 has a sufficiently large area in the surface direction against the gas pressure, and thus can exhibit the pressure resistance more effectively.

In the present embodiment, the aspect ratio of the scaly filler 2 can be obtained based on a ratio of an average major axis to an average thickness by measuring particle thicknesses (minor axes) from lateral directions of particles and particle diameters (=major axes) from upper directions of the particles using an optical microscope or a scanning electron microscope (SEM), and calculating an average value (SEM measurement method). The average particle diameter of the scaly filler 2 is the average major axis, and can also be obtained by laser diffraction.

The porous support 3 is preferably an inorganic material for supporting the polyimide resin 1. Examples of the inorganic material include zeolite, a porous ceramic membrane, and a porous glass membrane. In the present embodiment, the gas separation membrane 10 can be formed on the porous support 3 by pouring (coating or the like) the polyimide resin 1 containing the scaly filler 2 onto the porous support 3 and curing the resin.

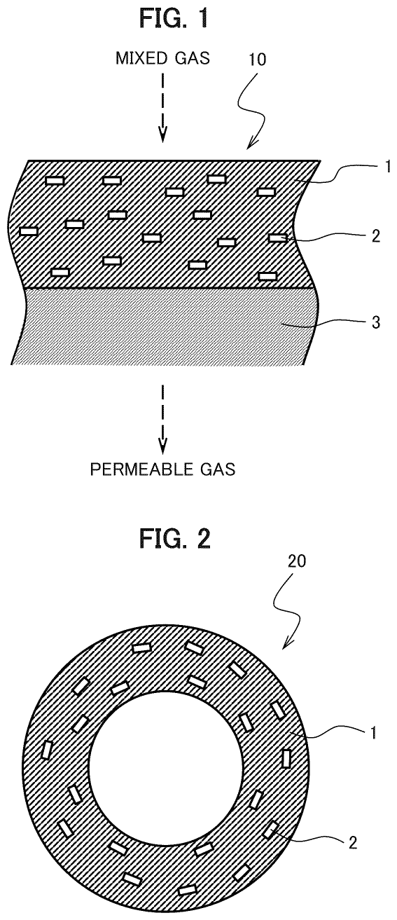

FIG. 2 is a schematic cross-sectional view showing an example of a gas separation membrane 20 according to a second embodiment of the invention. FIG. 2 illustrates a case where the gas separation membrane 20 is a hollow fiber membrane.

The gas separation membrane 10 shown in FIG. 1 and the gas separation membrane 20 shown in FIG. 2 are similar except a difference in that the gas separation membrane 10 is a flat membrane whereas the gas separation membrane 20 is a hollow fiber membrane. That is, similar to the gas separation membrane 10, the gas separation membrane 20 also includes the polyimide resin 1 and the scaly filler 2.

The gas separation membrane 20 that is a hollow fiber membrane can be manufactured, for example, by a wet deposition method with a coagulation liquid using a varnish obtained by impregnating the polyamic acid or polyamic acid ester described above with the scaly filler 2.

Similar to the above, when the gas separation membrane 20 is a hollow fiber membrane, the scaly filler 2 is also preferably arranged in a direction perpendicular to a gas permeation direction. When the gas separation membrane 20 is a hollow fiber membrane, such an arrangement is implemented by ejecting a polyimide solution containing the scaly filler 2 from a hollow fiber spinning nozzle according to the wet deposition method.

### Gas Separation Membrane Module

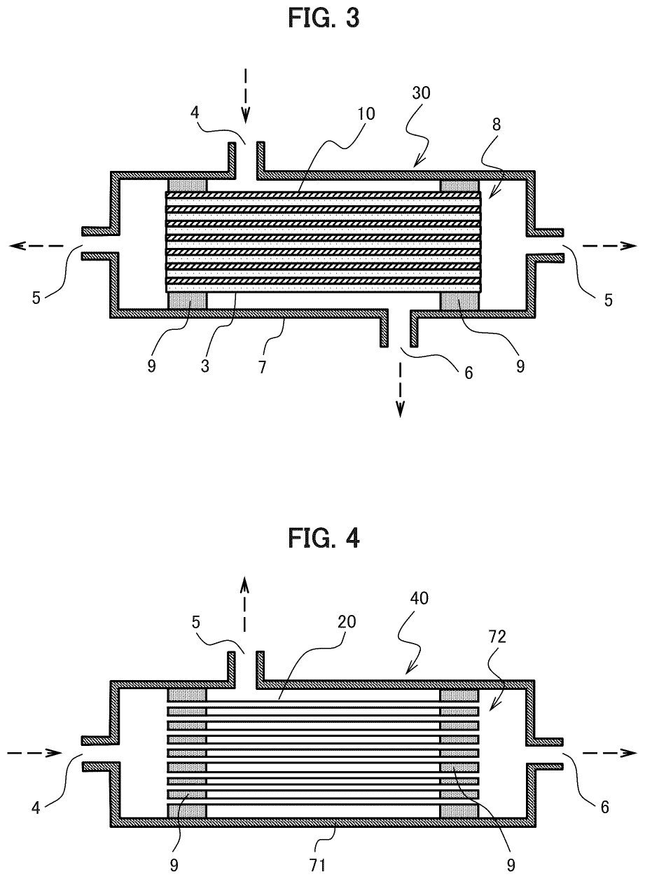

FIG. 3 is a schematic cross-sectional view showing an example of a gas separation membrane module 30 according to a third embodiment of the invention. FIG. 3 illustrates a case where the gas separation membrane 10 (flat membrane) is used.

As shown in FIG. 3, the gas separation membrane module 30 is configured such that a stacked element 8 including a plurality of gas separation membranes 10 according to the first embodiment is housed in a closed container 7. The gas separation membrane 10 is supported by the porous support 3.

The closed container 7 has at least a mixed gas inlet 4, permeable gas outlets 5, and a non-permeable gas outlet 6.

As shown in FIG. 3, both end portions of the stacked element 8 are fixed to the closed container 7 by resin walls 9 formed by solidifying a thermosetting resin such as an elastomer-based resin, an acrylate-based resin, an epoxy resin, or a phenol resin.

In the gas separation membrane module 30 shown in FIG. 3, the closed container 7 has a rectangular parallelepiped shape, and is provided with the mixed gas inlet 4 such that a mixed gas containing a water vapor flows perpendicularly to the gas separation membranes 10 that are flat membranes. The permeable gas outlets 5 are provided in a direction parallel to the gas separation membranes 10 that are the flat membranes (a direction perpendicular to a direction in which the mixed gas flows in). The non-permeable gas outlet 6 is provided in a surface of the closed container 7 opposite to the mixed gas inlet 4 with the gas separation membranes 10 that are the flat membranes interposed therebetween.

In the gas separation membrane module 30, the mixed gas that flows in from the mixed gas inlet 4 is separated by the gas separation membranes 10 into a permeable gas and a non-permeable gas. Examples of the mixed gas include a gas containing a high temperature and high pressure water vapor at 150° C. or higher or 180° C. or higher (upper limit of about 220° C.).

The gas that can permeate the gas separation membranes 10 contains, for example, molecules of water (water vapor), hydrogen, or the like, and molecules and atoms (ions) having a size equal to or smaller than that of hydrogen molecules.

The gas that does not permeate the gas separation membranes 10 contains, for example, molecules and atoms (ions) having a size larger than that of water (water vapor) or hydrogen, such as lithium (ions), sodium (ions), nitrogen, methane, carbon monoxide, carbon dioxide, molecules having a size equal to or larger than that, or a radioactive substance.

The gas that can permeate the gas separation membranes 10 flows out (is discharged) from the permeable gas outlets 5.

The gas that does not permeate the gas separation membranes 10 flows out from the non-permeable gas outlet 6.

FIG. 4 is a schematic cross-sectional view showing an example of a gas separation membrane module 40 according to a fourth embodiment of the invention. FIG. 4 illustrates a case where the gas separation membrane 20 (hollow fiber membrane) is used.

As shown in FIG. 4, in the gas separation membrane module 40, a yarn bundle element 72 including a large number of gas separation membranes 20 according to the second embodiment is housed in a cylindrical closed container 71.

The closed container 71 has at least the mixed gas inlet 4, a permeable gas outlet 5, and the non-permeable gas outlet 6.

As shown in FIG. 4, both end portions of the yarn bundle element 72 are fixed to the closed container 71 by the resin walls 9 formed by solidifying a thermosetting resin such as an elastomer-based resin, an acrylate-based resin, an epoxy resin, or a phenol resin.

The gas separation membrane module 40 shown in FIG. 4 is provided with the mixed gas inlet 4 such that a mixed gas containing a water vapor flows parallel to the gas separation membranes 20 that are hollow fiber membranes. The permeable gas outlet 5 is provided in a direction perpendicular to the gas separation membranes 20 that are the hollow fiber membranes (a direction perpendicular to a direction in which the mixed gas flows in). The non-permeable gas outlet 6 is provided at a position facing the mixed gas inlet 4 with the gas separation membranes 20 that are the hollow fiber membranes interposed therebetween.

In the gas separation membrane module 40, the mixed gas that flows in from the mixed gas inlet 4 is separated by the gas separation membranes 20 into a permeable gas and a non-permeable gas. Examples of the mixed gas include a gas containing a high temperature and high pressure water vapor at 150° C. or higher or 180° C. or higher (upper limit of about 220° C.).

The gas that can permeate the gas separation membranes 20 contains, for example, molecules of water (water vapor), hydrogen, or the like, and molecules and atoms (ions) having a size equal to or smaller than that of hydrogen molecules.

The gas that does not permeate the gas separation membranes 20 contains, for example, molecules and atoms (ions) having a size larger than that of water (water vapor) or hydrogen, such as lithium (ions), sodium (ions), nitrogen, methane, carbon monoxide, carbon dioxide, molecules having a size equal to or larger than that, or a radioactive substance.

The gas that can permeate the gas separation membranes 20 flows out from the permeable gas outlet 5.

The gas that does not permeate the gas separation membranes 20 flows out from the non-permeable gas outlet 6.

### Gas Permeable Apparatus

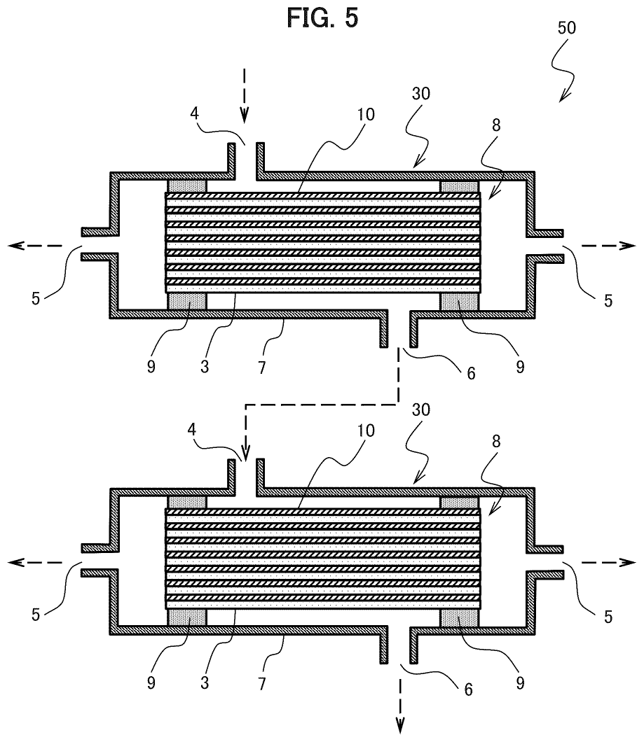

FIGS. 5 to 7 are schematic cross-sectional views showing examples of a gas permeable apparatus 50 according to a fifth embodiment of the invention. The gas permeable apparatus 50 shown in FIG. 5 includes a plurality of gas separation membrane modules 30 according to the third embodiment using the gas separation membranes 10 (flat membranes).

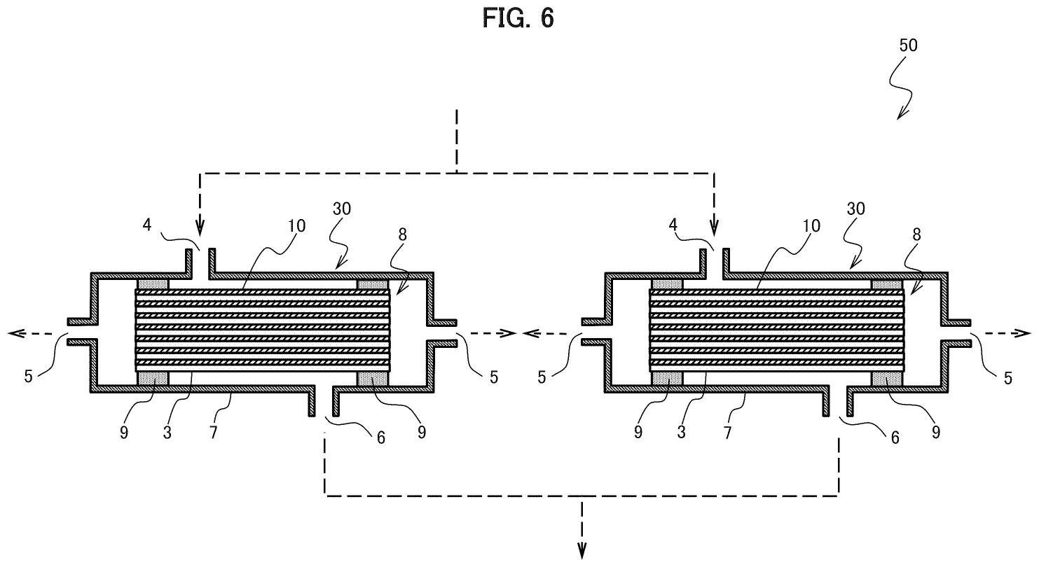

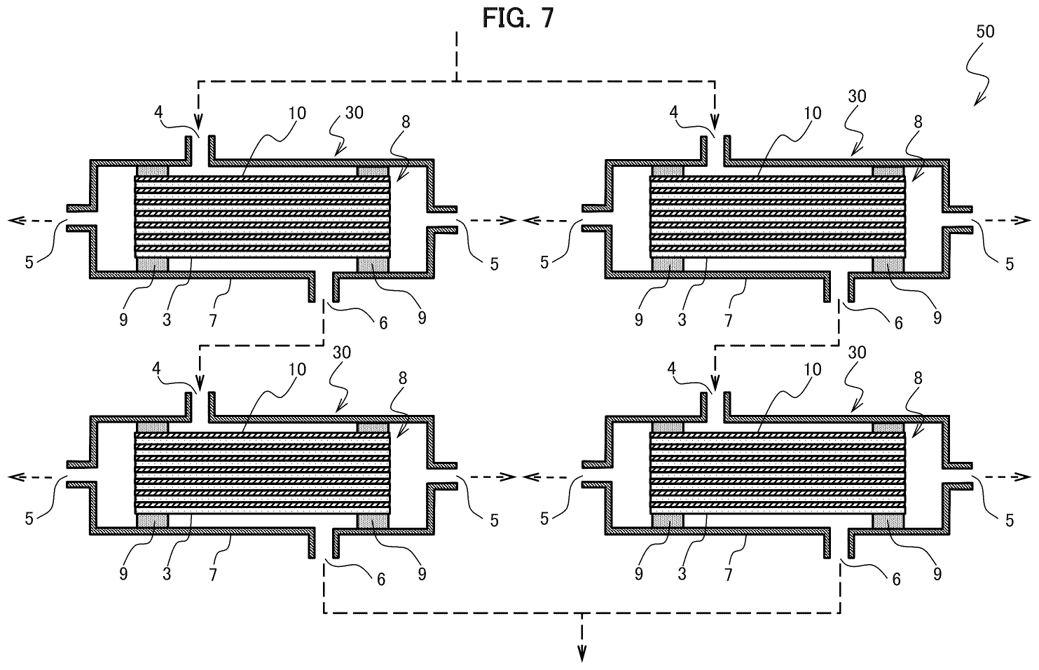

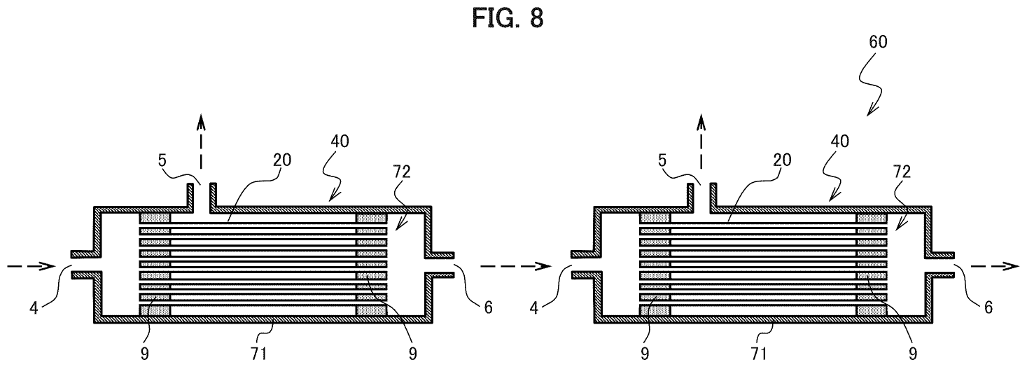

In the present embodiment shown in FIG. 5, two gas separation membrane modules 30 are provided, in each of which the gas separation membranes 10 are disposed in the closed container 7 having the mixed gas inlet 4, the permeable gas outlets 5, and the non-permeable gas outlet 6. In the present embodiment, the non-permeable gas outlet 6 of the preceding gas separation membrane module 30 is connected to the mixed gas inlet 4 of the subsequent gas separation membrane module 30, and the two are arranged in series. However, the gas permeable apparatus 50 is not limited to this mode. As shown in FIG. 6, the gas permeable apparatus 50 may include a plurality of gas separation membrane modules 30 arranged in parallel in the gas permeable apparatus 50. As shown in FIG. 7, the gas permeable apparatus 50 may include a plurality of gas separation membrane modules 30 arranged in parallel and a plurality of gas separation membrane modules 30 arranged in series in the gas permeable apparatus 50. The mode of the gas permeable apparatus 50 according to the present embodiment can be appropriately selected according to an amount of water vapor expected to be generated and a purity of the water vapor after permeating the gas permeable apparatus 50 (a content of impurities contained in the water vapor).

FIGS. 8 to 10 are schematic cross-sectional views showing examples of a gas permeable apparatus 60 according to a sixth embodiment of the invention. The gas permeable apparatus 60 shown in FIG. 8 includes a plurality of gas separation membrane modules 40 according to the fourth embodiment using the gas separation membranes 20 (hollow fiber membranes). That is, the examples shown in FIGS. 8 to 10 and the examples shown in FIGS. 5 to 7 described above differ from each other about whether the gas separation membrane module 40 according to the fourth embodiment using the gas separation membranes 20 (hollow fiber membranes) is used or the gas separation membrane module 30 according to the third embodiment using the gas separation membranes 10 (flat membranes) is used.

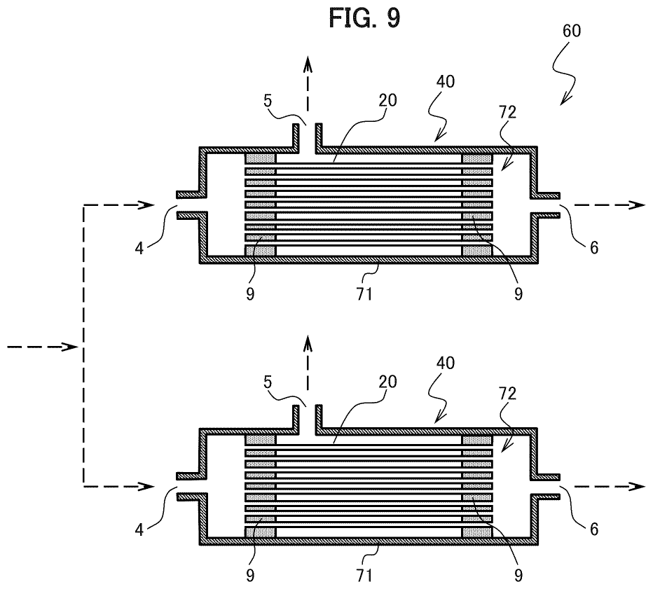

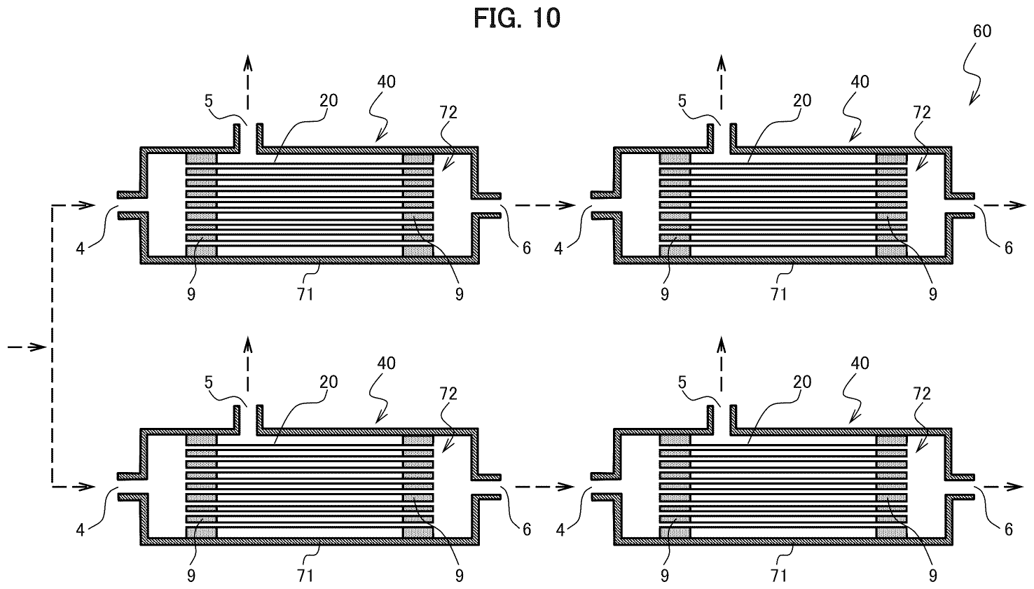

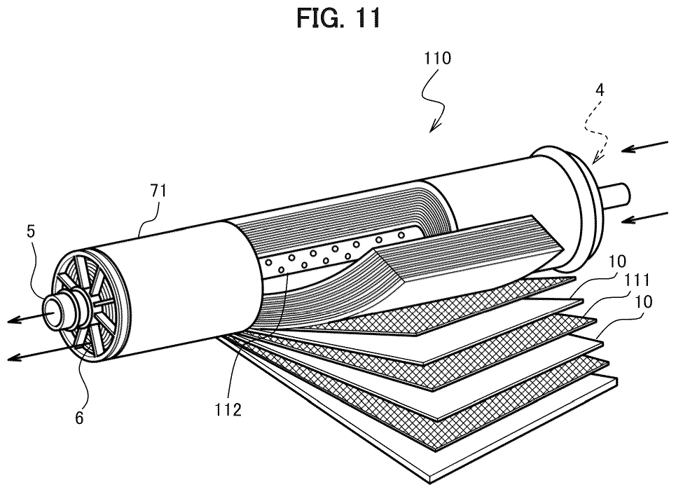

In the present embodiment shown in FIG. 8, two gas separation membrane modules 40 are provided, in each of which the gas separation membranes 20 are disposed in the closed container 7 having the mixed gas inlet 4, the permeable gas outlet 5, and the non-permeable gas outlet 6. In the present embodiment, the non-permeable gas outlet 6 of the preceding gas separation membrane module 40 is connected to the mixed gas inlet 4 of the subsequent gas separation membrane module 40, and the two are arranged in series. However, the gas permeable apparatus 60 is not limited to this mode. As shown in FIG. 9, the gas permeable apparatus 60 may include a plurality of gas separation membrane modules 40 arranged in parallel in the gas permeable apparatus 60. As shown in FIG. 10, the gas permeable apparatus 60 may include a plurality of gas separation membrane modules 40 arranged in parallel and a plurality of gas separation membrane modules 40 arranged in series in the gas permeable apparatus 60. The mode of the gas permeable apparatus 60 according to the present embodiment can be appropriately selected according to an amount of water vapor expected to be generated and a purity of the water vapor after permeating the gas permeable apparatus 60 (a content of impurities contained in the water vapor).

Although not shown, the gas separation membrane module 30 and the gas separation membrane module 40 may be used in combination in the present embodiment.

The gas separation membrane, the gas separation membrane module, and the gas permeable apparatus according to the present embodiment described above can be suitably used, for example, when it is desired to allow a gas having a small molecular size such as water (water vapor) or hydrogen to permeate and not to allow a gas having a molecular size larger than that of water (water vapor) or hydrogen to permeate from a mixture of a water vapor and another gas in a high temperature and high pressure water vapor environment of 180° C. or higher.

The gas separation membrane, the gas separation membrane module, and the gas permeable apparatus according to the present embodiment can be suitably used in facilities that have an extremely high temperature and high pressure water vapor atmosphere in various fields such as petrochemistry, chemistry, precision machinery, food, automobile, nuclear power, environment, biotechnology, and medical fields.

### EXAMPLES

Hereinafter, the invention will be described in more detail by comparing effective Examples with ineffective Comparative Examples, and the invention is not limited to the following Examples.

### Example 1

To a separable flask equipped with a stirring device and a nitrogen introduction tube, 4,4′-bis(3-aminophenoxy) biphenyl and pyromellitic anhydride were added equimolarly, and N-methyl-2-pyrrolidone (NMP) was charged thereto such that a concentration of the mixture was 15% by mass. Thereafter, under a nitrogen stream, the mixture was stirred in an ice bath for one hour and then at room temperature (20° C. to 25° C.) for seven hours to obtain a viscous polyamic acid solution (varnish).

Next, to the polyamic acid varnish, mica (M-XF, manufactured by Repco Inc.) having an average particle diameter of 4 μm and an average aspect ratio of 15 was charged as the scaly filler 2 in an amount of 5% by mass with respect to the polyamic acid solution, and the mixture was stirred at room temperature for 24 hours. The mica-containing polyamic acid varnish was diluted with NMP to an appropriate concentration and cast onto a glass. The mica-containing polyamic acid varnish cast on the glass was subjected to a deaeration treatment at room temperature for three hours under a reduced pressure, and then heated at 80° C. for two hours. Thereafter, the resultant was peeled off from the glass plate and heated at 100° C., 150° C., 200° C., and 250° C. under a reduced pressure for two hours each to obtain a mica-containing polyimide membrane (gas separation membrane 10) having a flat membrane shape.

Such a polyimide membrane was prepared in a number of ten, and ten pieces of plate-shaped zeolite were alternately interposed therebetween to form a cassette-structured element, thereby obtaining the gas separation membrane module 30 having the configuration shown in FIG. 3. Then, a nitrogen gas containing a water vapor (mixed gas) was supplied to the gas separation membrane module 30 to allow the water vapor to permeate (separate the water vapor).

First, the gas separation membrane module 30 was installed in a thermostatic chamber, and the mixed gas was supplied to the gas separation membrane module 30 at 180° C. to allow the water vapor to permeate. A pressure of the supply gas was 0.5 MPaG. A flow rate of the water vapor was adjusted such that an amount of water supplied was 0.5 ml.

The operation was continuously performed for 500 hours, and no decrease in pressure was observed. After the operation, the cassette was disassembled, and when an appearance of the polyimide membrane was checked, no cracks were observed and it was found to be in a good condition. As a result of the check by SEM, the scaly filler was arranged in a direction perpendicular to a gas permeation direction. Not all of the scaly fillers were neatly arranged perpendicularly, and there were overlapping parts, for example.

When a similar water vapor permeation test was carried out by increasing the amount of mica added to 28% by mass, an appearance of the polyimide membrane was good with no cracks observed.

Further, when a similar water vapor permeation test was carried out using mica (S-325, manufactured by Repco In.) having an average particle diameter of 27 μm and an average aspect ratio of 30 as the scaly filler in an amount of 0.3% by mass to 3% by mass, and boron nitride (GP particle size D50, Denka Company Limited.) having an average particle diameter of 8 μm and an average aspect ratio of 10 in an amount of 3% to 20% by mass with respect to the polyamic acid solution, an appearance of each polyimide membrane was good with no cracks observed.

### Example 2

To a separable flask equipped with a stirring device and a nitrogen introduction tube, 4,4′-diaminodiphenyl ether and 4,4′-oxydiphthalic anhydride were added equimolarly, followed by polymerization with p-chlorophenol at 180° C. for four hours to obtain a polyimide solution having a polymer concentration of 12% by mass.

Next, to the polyimide solution, mica (S-XF, manufactured by Repco In.) having an average particle diameter of 3 μm and an average aspect ratio of 15 was charged as the scaly filler 2 in an amount of 5% by mass with respect to the polyimide solution, and the mixture was stirred for six hours.

The obtained mica-containing polyimide solution was ejected from a hollow fiber spinning nozzle, and the ejected hollow fiber-shaped mica-containing polyimide was placed in a nitrogen atmosphere, and then was immersed in a coagulation liquid formed of a 72% by mass ethanol aqueous solution at 0° C. to obtain a wet yarn. The wet yarn was immersed in ethanol at 50° C. for two hours and dehydrated. Further, the resultant was immersed in isooctane at 80° C. for three hours, and then dried to 100° C., and then a heat treatment was performed by raising the temperature stepwise to 250° C. to obtain a hollow fiber membrane (gas separation membrane 20).

An element for evaluation having an effective length of about 5 cm was prepared using 50 such hollow fiber membranes, a stainless steel pipe, and an epoxy resin as a cured resin. This element was attached to a stainless steel container to obtain the gas separation membrane module 40 having the configuration shown in FIG. 4. Then, a nitrogen gas containing a water vapor (mixed gas) was supplied to the gas separation membrane module 40 to allow the water vapor to permeate (separate the water vapor).

First, the gas separation membrane module 40 was installed in a thermostatic chamber, and the mixed gas was supplied to the gas separation membrane module 40 at 180° C. to allow the water vapor to permeate. A pressure of the supply gas was 0.5 MPaG. A flow rate of the water vapor was adjusted such that an amount of water supplied was 0.5 ml.

The operation was continuously performed for 100 hours, and no change in pressure was observed. After the operation, the module was disassembled, and when an appearance of the hollow fiber membrane was checked, no cracks were observed and it was found to be in a good condition. As a result of the check by SEM, the scaly filler was arranged in a direction perpendicular to a gas permeation direction. Not all of the scaly fillers were neatly arranged perpendicularly, and there were overlapping parts, for example.

When a similar water vapor permeation test was carried out by increasing the amount of mica added to 30% by mass, an appearance of the hollow fiber membrane was good with no cracks observed.

In addition, when a similar water vapor permeation test was carried out using mica (M-400, manufactured by Repco In.) having an average particle diameter of 24 μm and an average aspect ratio of 28 as the scaly filler in an amount of 0.2% by mass to 2% by mass, and boron nitride (GP particle size D50, Denka Company Limited.) having an average particle diameter of 8 μm and an average aspect ratio of 10 in an amount of 3% by mass to 20% by mass with respect to the polyamic acid solution, an appearance of each hollow fiber membrane was good with no cracks observed.

### Comparative Example 1

A polyamic acid solution was prepared using the same method and raw materials as in Example 1 described above. Next, the polyamic acid solution (varnish) was diluted with NMP to an appropriate concentration and cast onto a glass. The polyamic acid varnish cast on the glass was subjected to a deaeration treatment at room temperature for three hours under a reduced pressure, and then heated at 80° C. for two hours. Thereafter, the resultant was peeled off from the glass plate and heated at 100° C., 150° C., 200° C., and 250° C. under a reduced pressure for two hours each to obtain a polyimide membrane. The polyimide membrane according to Comparative Example 1 may correspond to the gas separation membrane disclosed in PTL 1 formed of a flat membrane in that the polyimide membrane does not contain mica.

Ten such polyimide membranes were prepared, and ten pieces of plate-shaped zeolite were alternately interposed therebetween to form a cassette-structured element, thereby obtaining a gas separation membrane module having the configuration shown in FIG. 3. Then, a nitrogen gas containing a water vapor (mixed gas) was supplied to the gas separation membrane module to allow the water vapor to permeate (separate the water vapor).

First, the gas separation membrane module was installed in a thermostatic chamber, and the mixed gas was supplied to the gas separation membrane module at 180° C. to allow the water vapor to permeate. A pressure of the supply gas was 0.5 MPaG. A flow rate of the water vapor was adjusted such that an amount of water supplied was 0.5 ml.

After 50 hours of continuous operation, the pressure started to gradually decrease, and thus the pressure of the supply gas was adjusted to 0.5 MPaG. However, the pressure decreased continuously even after that, and the pressure suddenly decreased after 100 hours. Based on this, it was determined that the polyimide membrane was broken, and the operation was stopped. After the operation, the cassette was disassembled, and when an appearance of the polyimide membrane was checked, it was confirmed that cracks occurred in a part of the polyimide membrane. From the results of Comparative Example 1, it was confirmed that even when the plate-shaped zeolite was used, it was not possible to obtain a desired effect unless the scaly filler 2 was used.

In addition, a similar water vapor permeation test was carried out using mica (S-150H, manufactured by Repco In.) having an average particle diameter of 160 μm and an average aspect ratio of 80 as the scaly filler in an amount of 25% by mass with respect to the polyamic acid solution. As a result, since the pressure gradually decreased, the operation was stopped after 300 hours. After the operation, the cassette was disassembled, and when an appearance of the polyimide membrane was checked, it was confirmed that cracks occurred in a part of the polyimide membrane.

### Comparative Example 2

A polyimide solution was prepared using the same method and raw materials as in Example 2 described above. Then, a hollow fiber membrane was obtained using the same method as in Example 2. The polyimide membrane according to Comparative Example 2 may correspond to the gas separation membrane disclosed in PTL 1 formed of a hollow fiber membrane in that the polyimide membrane does not contain mica.

An element for evaluation having an effective length of about 5 cm was prepared using 50 such hollow fiber membranes, a stainless steel pipe, and an epoxy resin as a cured resin. This element was attached to a stainless steel container to obtain the gas separation membrane module having the configuration shown in FIG. 4. Then, a nitrogen gas containing a water vapor (mixed gas) was supplied to the gas separation membrane module to allow the water vapor to permeate (separate the water vapor).

First, the gas separation membrane module was installed in a thermostatic chamber, and the mixed gas was supplied to the gas separation membrane module at 180° C. to allow the water vapor to permeate. A pressure of the supply gas was 0.5 MPaG. A flow rate of water vapor was adjusted such that an amount of water supplied was 0.5 ml.

After 15 hours of continuous operation, the pressure suddenly decreased, and thus it was determined that the hollow fiber membrane was broken, and the operation was stopped. After the operation, the module was disassembled, and when an appearance of the hollow fiber membrane was checked, it was confirmed that several hollow fibers were broken and embrittlement of the hollow fiber membrane was observed.

In addition, a similar water vapor permeation test was carried out using mica (M-325, manufactured by Repco In.) having an average particle diameter of 26 μm and an average aspect ratio of 20 as the scale-like filler in an amount of 50% by mass with respect to the polyimide acid solution. As a result, since the pressure gradually decreased, the operation was stopped after 60 hours. After the operation, the module was disassembled, and when an appearance of the hollow fiber membrane was checked, it was confirmed that several hollow fiber membranes were broken.

Although the gas separation membrane, the gas separation membrane module, and the gas permeable apparatus according to the invention have been described in detail above in the embodiments and Examples, the invention is not limited to the above-described embodiments and Examples, and includes various modifications. For example, the above-described embodiments have been described in detail to facilitate understanding of the invention, and the invention is not necessarily limited to those including all the configurations described above. Further, a part of a configuration according to a certain embodiment can be replaced with a configuration according to another embodiment, and a configuration according to a certain embodiment can be added to a configuration according to another embodiment. A part of a configuration according to each embodiment may be deleted, added with, or replaced with another configuration.

For example, in addition to being a flat membrane or a hollow fiber membrane, the gas separation membrane may be of a pleated type membrane (not shown) formed by folding the flat membrane a plurality of times. Since the pleated type gas separation membrane has a membrane surface area larger than that of the flat membrane, treatment efficiency is improved.

FIG. 11 is a schematic view showing an example of a gas separation membrane module 110 using spiral type gas separation membranes 10. The gas separation membrane module 110 shown in FIG. 11 is formed by spirally winding the gas separation membranes 10 that are flat membranes.

As shown in FIG. 11, in a case of the spiral type membrane obtained by winding the gas separation membranes 10 that are the flat membranes into a spiral shape, even when a strength of each gas separation membrane 10 is not sufficiently high, the strength is increased by winding the gas separation membranes 10 into the spiral shape, and thus this spiral type membrane can be suitably used without the porous support 3 or the like. As shown in FIG. 11, when a form of the gas separation membrane 10 in the gas separation membrane module 110 is of the spiral type membrane, the gas separation membrane 10 and a gas flow path member 111 formed of a porous material may be alternately provided in the cylindrical closed container 71.

One end surface of the cylindrical closed container 71 serves as the mixed gas inlet 4, and the other end surface thereof serves as the non-permeable gas outlet 6. In the gas separation membrane module 110, a cylindrical body 112 having holes in a side surface thereof is arranged at a center of the gas separation membranes 10 wound into the spiral shape. The cylindrical body 112 has the permeable gas outlet 5 in the other end surface of the cylindrical closed container 71.

A mixed gas that flows in from the mixed gas inlet 4 passes through the gas flow path member 111, and molecules of water (water vapor), hydrogen, or the like, and molecules, atoms (ions) and the like having a size equal to or smaller than that of hydrogen molecules permeate the gas separation membranes 10 and flow into the cylindrical body 112. The molecules, atoms (ions), and the like that flow into the cylindrical body 112 pass through the cylindrical body 112 and flow out from the permeable gas outlet 5.

On the other hand, molecules, atoms (ions), and the like having a size larger than that of water (water vapor) or hydrogen cannot permeate the gas separation membranes 10, and flow out from the non-permeable gas outlet 6 through the gas flow path member 111. That is, the gas that flows out from the non-permeable gas outlet 6 may contain molecules and atoms (ions) having a size larger than that of water (water vapor) or hydrogen, which do not permeate the gas separation membranes 10.

It is understood that the foregoing description is that of the preferred embodiments of the invention and that various changes and modifications may be made thereto without departing from the spirit and scope of the invention as defined in the appended claims.

What is claimed is:

1. A gas separation membrane comprising:
a polyimide resin; and
a scaly filler.

2. The gas separation membrane according to claim 1, wherein
the scaly filler is at least one of mica, silica, boron nitride, and a glass flake.

3. The gas separation membrane according to claim 1, wherein
a content of the scaly filler is 0.2% by mass or more and 30% by mass or less.

4. The gas separation membrane according to claim 1, wherein
an average particle diameter of the scaly filler is 2 μm or more and 30 μm or less.

5. The gas separation membrane according to claim 1, wherein
an aspect ratio of the scaly filler is 10 or more and 30 or less.

6. The gas separation membrane according to claim 1, wherein
the scaly filler is arranged in a direction perpendicular to a gas permeation direction.

7. The gas separation membrane according to claim 1, wherein
a form of the membrane is a hollow fiber membrane, a flat membrane, a pleated type membrane formed by folding the flat membrane a plurality of times, or a spiral type membrane formed by winding the flat membrane into a spiral shape.

8. The gas separation membrane according to claim 1, further comprising:
a porous support configured to support the gas separation membrane.

9. The gas separation membrane according to claim 1, wherein
a dynamic molecular diameter of a permeable molecule is 0.3 nm or less.

10. A gas separation membrane module, comprising:
the gas separation membrane according to claim 1 disposed in a closed container having a mixed gas inlet, a permeable gas outlet, and a non-permeable gas outlet.

11. The gas separation membrane module according to claim 10, wherein
a form of the gas separation membrane is a hollow fiber membrane, a flat membrane, a pleated type membrane formed by folding the flat membrane a plurality of times, or a spiral type membrane formed by winding the flat membrane into a spiral shape.

12. A gas permeable apparatus comprising:
two or more gas separation membrane modules, in each of which the gas separation membrane according to claim 1 is disposed in a closed container having a mixed gas inlet, a permeable gas outlet, and a non-permeable gas outlet.
